(19) United States
(12) Patent Application Publication
(10) Pub. No.: US 2025/0346447 A1
(43) Pub. Date: Nov. 13, 2025

(54) MODULAR HOPPER FOR A COMPACTOR SYSTEM

(71) Applicant: Marathon Equipment Company, South Vernon, AL (US)

(72) Inventors: Bradley Michael Agoston, Fayette, AL (US); Jeffrey Clark Roney, Cumming, GA (US); Anton Nasledov, Chattanooga, TN (US); Daniel Robert Overstreet, Caledonia, MS (US); Jordan Lee Sandlin, Carmel, IN (US); Lokesh Krishna, Vernon, AL (US)

(21) Appl. No.: 18/660,704

(22) Filed: May 10, 2024

(51) Int. Cl. B65G 65/34; B30B 15/30

(52) U.S. Cl. CPC B65G 65/34; B30B 15/30

(57) ABSTRACT

Systems and methods include a modular hopper including a first side wall including a rear edge, a back edge, a top edge, and a bottom edge; a second side wall comprising a rear edge, a back edge, a top edge, and a bottom edge; a rear wall removably fastened to the rear edge of the first side wall along a first edge and removably fastened to the rear edge of the second side wall along a second edge opposite the first edge. Each of the first side wall, the second side wall, and the rear wall defines a refuse receiving opening configured to enable access to an interior of the modular hopper. The refuse receiving openings defined in the first side wall, the second side wall, and the rear wall have substantially similar dimensions, and the modular hopper is configured to be removably fastened to a compactor system.

### TECHNICAL FIELD

This disclosure relates to compactor systems.

### BACKGROUND

Refuse compactor systems can provide many benefits for businesses including reducing the volume of refuse, reducing costs associated with hauling refuse, reducing odors and fire damage, and protecting against pests. Self-contained compactor systems include a compactor with a storage or container body attached to the compactor in a single, portable structure. For example, self-contained compactors can be hauled to the landfill as a single unit to empty the collected refuse. Self-contained compactors are useful when a compactor resides in place for extended periods of time as it collects refuse materials. Self-contained compactors can include a hopper or what is colloquially called a “doghouse” (e.g., an enclosed hopper) to facilitate collection of refuse at a location and/or to prevent unauthorized access to the compactor system. Typically, hoppers are welded to the compactor system.

### SUMMARY

In an example implementation, a modular hopper for a compactor system includes a first side wall including a rear edge, a back edge, a top edge, and a bottom edge; a second side wall including a rear edge, a back edge, a top edge, and a bottom edge; a rear wall removably fastened to the rear edge of the first side wall along a first edge and removably fastened to the rear edge of the second side wall along a second edge opposite the first edge; and each of the first side wall, the second side wall, and the rear wall defining a refuse receiving opening configured to enable access to an interior of the modular hopper, the refuse receiving openings defined in the first side wall, the second side wall, and the rear wall having substantially similar dimensions; where the modular hopper is configured to be removably fastened to a compactor system.

In an aspect combinable with the example implementation, the back edges of the first side wall and the second side wall are configured to be removably fastened to the compactor system.

In another aspect combinable with any of the previous aspects, the first side wall, the second side wall, and the rear wall are configured to be removably fastened to the compactor system along a bottom edge of the respective first side wall, the second side wall and the rear wall.

Another aspect combinable with any of the previous aspects includes a roof removably fastened to the top edge of the first side wall, the second side wall, and the rear wall.

Another aspect combinable with any of the previous aspects includes one or more doors removably fastened to one or more of the first side wall, the second side wall, and the rear wall, where the one or more doors includes a hinge to allow the door to rotate from a closed position sealing the refuse receiving opening in the first side wall, the second side wall, or the rear wall, and an open position that allows access to the refuse receiving opening; and a latch to secure the door when in the closed position.

Another aspect combinable with any of the previous aspects includes an interlock system attached to the modular hopper configured to prevent operation of the compactor system when the one or more doors are in the open position.

Another aspect combinable with any of the previous aspects includes one or more cover plates removably fasted to one or more of the first side wall, the second side wall and the rear wall, the one or more cover plates covering the refuse receiving opening in the respective wall.

In another aspect combinable with any of the previous aspects, the first side wall, the second side wall, and the rear wall include a standard bolt pattern surrounding the refuse receiving openings to allow interchangeability of doors and cover plates.

In another aspect combinable with any of the previous aspects, joints between the first side wall, the second side wall, the rear wall, and the compactor system include a sealant to reduce liquid seepage through the joints.

In another aspect combinable with any of the previous aspects, removably fastened includes being fastened with one or more of bolts, nuts, screws, and rivets.

In another example implementation, a compactor system includes a packer including a ram; a container body; hydraulics for actuating the ram to compact debris contained within the packer to the container body; and a modular hopper configured to receive debris into the packer, the modular hopper including a first side wall including a rear edge, a back edge, a top edge, and a bottom edge; a second side wall including a rear edge, a back edge, a top edge, and a bottom edge; a rear wall removably fastened to the rear edge of the first side wall along a first edge and removably fastened to the rear edge of the second side wall along a second edge opposite the first edge; and each of the first side wall, the second side wall, and the rear wall defining a refuse receiving opening configured to enable access to an interior of the modular hopper, the refuse receiving openings defined in the first side wall, the second side wall, and the rear wall having substantially similar dimensions; where the modular hopper is configured to be removably fastened to the packer, the container body, or both.

In an aspect combinable with the example implementation, the back edges of the first side wall and the second side wall are configured to be removably fastened to the container body.

In another aspect combinable with any of the previous aspects, the first side wall, the second side wall, and the rear wall are configured to be removably fastened to the packer along a bottom edge of the respective first side wall, the second side wall and the rear wall.

In another aspect combinable with any of the previous aspects, the modular hopper includes a roof removably fastened to the top edge of the first side wall, the second side wall, and the rear wall.

Another aspect combinable with any of the previous aspects, further comprising one or more doors removably fastened to one or more of the first side wall, the second side wall, and the rear wall, wherein the one or more doors include a hinge to allow the door to rotate from a closed position sealing the refuse receiving opening in the first side wall, the second side wall, or the rear wall, and an open position that allows access to the refuse receiving opening; and a latch to secure the door when in the closed position.

Another aspect combinable with any of the previous aspects includes an interlock system attached to the modular hopper configured to prevent operation of the compactor system when the one or more doors are in the open position.

Another aspect combinable with any of the previous aspects includes one or more cover plates removably fasted to one or more of the first side wall, the second side wall and the rear wall, the one or more cover plates covering the refuse receiving opening in the respective wall.

In another aspect combinable with any of the previous aspects, the first side wall, the second side wall, and the rear wall include a standard bolt pattern surrounding the refuse receiving openings to allow interchangeability of doors and cover plates.

In another aspect combinable with any of the previous aspects, joints between the first side wall, the second side wall, the rear wall, and the packer and/or the container body include a sealant to reduce liquid seepage through the joints.

In another aspect combinable with any of the previous aspects, removably fastened includes being fastened with one or more of bolts, nuts, screws, and rivets.

In another example implementation, a method for assembling a modular hopper on a compactor system includes obtaining a first side wall; a second side wall, and a rear wall for a modular hopper; removably fastening the first and second side walls and the rear wall to the compactor system; removably fastening the first side wall to a first edge of the rear wall; removably fastening the second side wall to a second edge of the rear wall opposite the first edge; removably fastening a front edge of the first and second side walls to the compactor system; and removably fastening one or more doors or cover plates to one or more of the first and second side walls and the rear wall.

An aspect combinable with the example implementation includes removably fastening a roof to the first and second side walls and the rear wall.

Another aspect combinable with any of the previous aspects includes removably fastening a latch to the one or more doors.

In another aspect combinable with any of the previous aspects, a location to fasten the latch to the door is selected from a set of predetermined locations on the one or more doors, each predetermined location includes a standard attachment pattern for removably fastening the latch.

Another aspect combinable with any of the previous aspects includes sealing joints between the first and second side walls, the rear wall, and the compactor system.

In another aspect combinable with any of the previous aspects, removably fastening includes fastening with one or more of bolts, nuts, screws, and rivets.

Another aspect combinable with any of the previous aspects includes removing a door from the first side wall; and removably fastening the door to the second side wall or the rear wall.

In another aspect combinable with any of the previous aspects, removably fastening the door to the second side wall or the rear wall includes removing a latch in a first position from the door; and removably fastening the latch to the door in a second position different than the first position.

Another aspect combinable with any of the previous aspects includes removably fastening an interlock system to the one or more doors to prevent operation of the compactor system when the one or more doors are in an open position.

In another example implementation, a kit for a modular hopper includes a includes a first side wall including a rear edge, a back edge, a top edge, and a bottom edge; a second side wall including a rear edge, a back edge, a top edge, and a bottom edge; a rear wall; and each of the first side wall, the second side wall, and the rear wall defining a refuse receiving opening configured to enable access to an interior of the modular hopper, the refuse receiving openings defined in the first side wall, the second side wall, and the rear wall having substantially similar dimensions; where the modular hopper is configured to be removably fastened to a compactor system.

An aspect combinable with the example implementation includes a roof configured to be removably fastened to the top edge of the first side wall, the second side wall, and the rear wall.

Another aspect combinable with any of the previous aspects includes one or more doors, where each door includes a door panel attached to a door frame by a hinge, the one or more doors configured to be removably fastened to the first sidewall, the second sidewall, and/or the rear wall.

Another aspect combinable with any of the previous aspects includes one or more latches configured to be attached to the one or more doors to latch the door panel to the frame.

In another aspect combinable with any of the previous aspects, the door frame includes a standard bolt pattern surrounding matching a standard bolt pattern on surrounding the refuse receiving openings on the first side wall, the second side wall, and the rear wall to enable the door to be removably fastened to the first side wall, the second side wall or the rear wall.

Another aspect combinable with any of the previous aspects includes one or more cover plates configured to be removably fastened to cover the refuse receiving opening in the first side wall, the second side wall, or the rear wall.

Particular implementations of the subject matter described in this specification can be implemented so as to realize one or more of the following advantages.

For example, the modular hoppers described in this disclosure are purpose-built to be reconfigurable and accommodate the changing needs or requirements for a compactor system. In some implementations, the configuration for the modular hopper can be changed in the field or during production without requiring a skilled welder. The doors and cover plates can be installed on the modular hopper at any opening in the side or rear walls. A standard bolt pattern and standard opening sizes between the base unit of the modular hopper and the doors and cover plates enables interchangeability of the components. The modularity of the hopper can reduce stored part counts because the hopper unit can be configured in any configuration from a small number of standard, interchangeable parts.

It is appreciated that methods in accordance with the present specification may include any combination of the aspects and features described herein. That is, methods in accordance with the present specification are not limited to the combinations of aspects and features specifically described herein, but also include any combination of the aspects and features provided.

The details of one or more implementations of the subject matter described in this disclosure are set forth in the accompanying drawings and the description below. Other features, objects, and advantages of the subject matter will be apparent from the description and drawings, and from the claims.

### DESCRIPTION OF DRAWINGS

FIG. 1 is a perspective view of an example compactor system with a modular hopper.

FIGS. 2A-2D are perspective views of certain components of an example modular hopper.

FIGS. 3A-3B are front and rear views of an example door for a modular hopper.

FIGS. 4A-4C are front views of example doors for a modular hopper with the hinge on the right side of the doors and various positions of a latch on the left side of the doors.

FIGS. 5A-5C are front views of example doors for a modular hopper with the hinge on the left side of the doors and various positions of a latch on the right side of the doors.

FIG. 6 is a grid of configurations for example modular hoppers without a roof.

FIG. 7 is a grid of configurations for example modular hoppers with a roof.

FIG. 8 is a perspective view of an example compactor system including a modular hopper and an interlock system.

FIGS. 9A-9B are detail views of example installation locations for an interlock system.

### DETAILED DESCRIPTION

Various embodiments of the present disclosure feature a modular hopper, e.g., for a self-contained compactor. In some implementations, the modular hopper includes a base unit, hinged doors, and/or cover plates. The base unit includes openings in the side and rear walls. The hinged doors and/or cover plates can be fitted to cover any or all of the openings in the base unit depending on a desired configuration for the modular hopper. Some implementations also include a roof attached to the base unit.

Conventional hoppers are welded to compactor systems. An original equipment manufacturer (OEM), an after-market supplier, or a user selects a desired configuration of the hopper, and the hopper is welded in place. For example, the side and rear walls are welded to the compactor system, and hinges and/or latching mechanisms for doors on the hopper are welded to the walls of the hopper and the door. The perceived ease of design and fabrication of this conventional approach has led to its prevalence in the industry. However, the conventional approach provides little flexibility for changing the hopper configuration after original installation without requiring significant rework by a skilled welder (e.g., grinding current welds, cutting new material, rewelding parts into new configurations) which increases costs in changing the design. Additionally, each hopper configuration may require unique parts requiring manufacturers and/or users to stock countless parts to produce or reconfigure a hopper. Original assembly and/or rework are typically done in a manufacturing facility due to the required tooling resulting in increased freight costs when shipping fully assembled hoppers and/or compactor systems.

The approach of the present disclosure provides a modular hopper that can be configured during production in a manufacturing facility or while deployed at a field location. The modular hopper can be easily reconfigured based on the needs of a particular use or deployment location. The modular hopper uses a standardized refuse receiving opening in each wall of the hopper. A door or cover plate can be installed to cover each refuse receiving opening and the doors and cover plates can be interchanged between openings on different walls of the modular hopper based on the desired configuration. Counter to the conventional approach, the modular hopper of this disclosure decreases complexity of the hopper and reduces parts inventory stocked by a user or manufacturer by using standardized doors that can be configured based on the application (e.g., hinge and latch positions can be configured as desired). The modular hopper can be assembled using removable fasteners without the need for welding (in some implementations). The modular hopper can also be shipped in a disassembled condition and assembled on site without welding thereby reducing shipping costs of the modular hopper and the required skill level of the assembler.

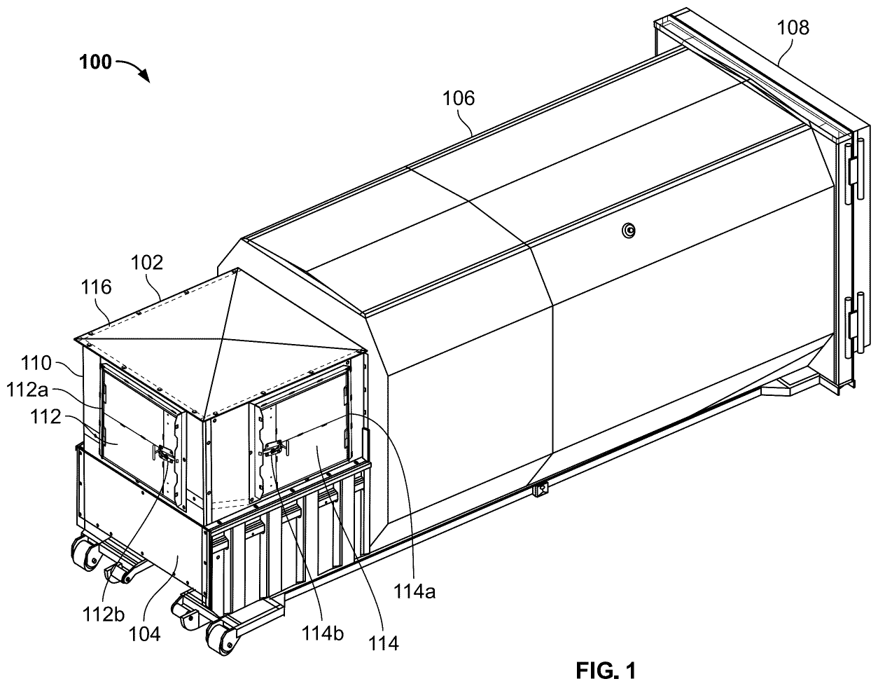

FIG. 1 is a perspective view of an example compactor system 100 including a modular hopper 102. The compactor system 100 includes a packer 104 and a container body 106. The modular hopper 102 is removably fastened (e.g., bolted, screwed, riveted, etc.) to the packer 104 and the container body 104. The container body 106 includes a door 108 that can be opened to empty the contents of the container body 106. The packer 104 includes a ram and hydraulics to actuate the ram to compact refuse that is placed in the packer 104. The ram compacts the refuse into the container body 106. A compactor system can be retrofitted with a modular hopper by adding flanges to the attachment points to removably fasten the modular hopper to the compactor system.

The modular hopper 102 includes a base unit 110, doors 112, 114 and a roof 116. The side of the modular hopper 102 that is not visible in FIG. 1 also includes a door or cover plate. The modular hopper 102 facilitates the input of refuse into the packer 104. For example, a user can open one of the doors 112, 114 and place refuse into the packer through the opening. The modular hopper 102 can also be configured to prevent unauthorized access by people and/or animals to the packer 104. For example, the doors 112, 114 can prevent animals from accessing the interior of the packer 104. In some implementations, the doors 112, 114 are locked to prevent unauthorized people from accessing the packer.

The doors 112, 114 form self-contained units that facilitate interchangeability and reconfiguration between different openings in the base unit 110. The doors 112, 114 are configured with hinges 112a, 114a, and latches 112b, 114b. The doors 112, 114 are removably fastened to the base unit 110. For example, the doors 112, 114 can be configured to have the hinge on the right side or the left side of the door by rotating the door 112, 114 around an axis normal to the plane of the door 112, 114 during installation of the door on the base unit 110. The doors 112, 114 can include a standard bolt pattern that enables the doors 112, 114 to be interchangeable. For example, a door can be moved from one side wall to a different side wall or rear wall. Cover plates and doors be interchanged by removing one and installing the other. For example, one of the doors 112, 114 can be removed and replaced with a cover plate without having to remove additional components (e.g., hinges, door frames, etc.).

The modular hopper 102 can be sealed to prevent liquids from seeping through the joints of the base unit 110 by applying a sealant (e.g., silicone, caulk, gasket, rubber) to the joints during assembly and installation of the modular hopper. Sealant can also be applied between the modular hopper 102 and the packer 104, between the modular hopper 102 and the container body 106, between the base unit 110 and the roof 116, and between the doors 112, 114 and/or cover plates and the base unit 110. In general, sealant can be applied to any joints or seams of the modular hopper 102.

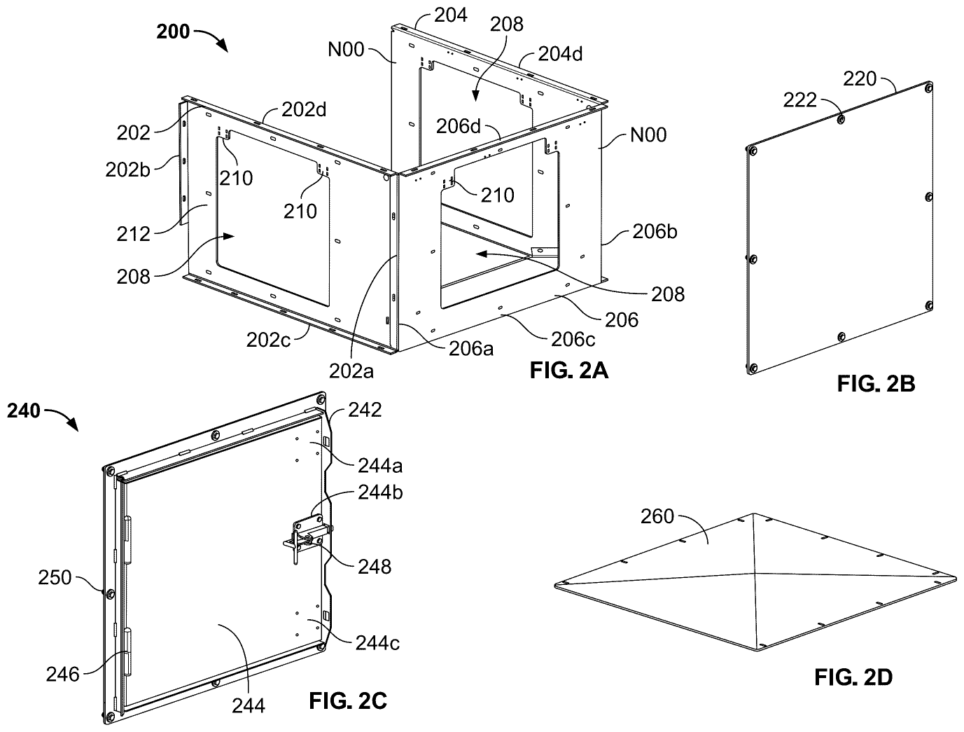

FIG. 2A is a perspective view of an example base unit 200 for a modular hopper of a compactor system. The base unit includes side walls 202, 204 and rear wall 206. The rear edge 202a, 204a of the side walls 202, 204 are removably attached to the side edges 206a, 206b of the rear wall 206. The bottom edges 202c, 204c include flanges to facilitate attachment with the compactor system. The base unit 200 can be made from any suitable material (e.g., steel, steel alloys, aluminum).

Each of the side walls 202, 204 and the rear wall 206 include an opening 208 (e.g., a refuse receiving opening). The opening 208 has the same dimensions or substantially the same dimensions in each side wall 202, 204 and the rear wall 206. Substantially the same dimensions or substantially similar dimensions means that the dimensions are sufficiently similar to facilitate the interchangeability of components described throughout this disclosure. For example, the dimensions can be substantially the same or similar when they are within 5% of one another. The openings 208 having the same or similar dimensions allows doors and cover plates to be interchangeably attached to the base unit 200 in a variety of configurations. A standard bolt pattern 212 can be used around each opening 208 to facilitate interchangeability between different components. In use, the openings 208 in the base unit 200 can be left open or can be covered by any combination of doors or cover plates.

Interlock attachment points 210 are located at corners of the opening 208 and enable an interlock system to be installed on the base unit according to the direction a door is installed on the base unit 200 opens. For example, when a door opens with the hinge on the left side, then the interlock can be installed on the right interlock attachment point 210 and vice versa.

FIG. 2B is a perspective view of an example cover plate 220 for a modular hopper unit. The cover plate 220 is sized to cover the openings 208 in the base unit 200. Bolts 222 are arranged in a standard pattern to match the standard bolt pattern 212 on the base unit 200. The cover plate 220 can be made from any suitable material (e.g., steel, steel alloys, aluminum).

FIG. 2C is a perspective view of an example door assembly 240 for a modular hopper unit. The door assembly 240 includes a door frame 242 and a door panel 244. The door panel 244 is attached to the door frame 242 by a hinge 246. A latch 248 is attached to the door panel 244 on the edge of the door panel 244 opposite the hinge 246. The door panel includes three latch positions 244a-c. The latch 248 can be installed in any one of the latch positions 244a-c depending on the door configuration desired. The latch 248, as shown, is installed in the middle latch position 244b of the door panel. The latch 248 interfaces with the door frame 242 to maintain the door in a closed position. The door frame 242 includes a bolt pattern 250 that aligns with the bolt pattern 212 in the base unit 200 and the bolt pattern 222 in the cover plate 220. The door assembly 240 can be mounted on the base unit 200 with the hinge 246 on either the left side or the right side of the door panel 244.

FIG. 2D is a perspective view of an example roof 260 for a modular hopper. In implementations desiring an enclosed hopper, the roof 260 can be attached to the top of the base unit 200. For example, the roof 260 can be attached to top edges, 202d, 204d, and 206d. The roof 260 can be attached to the base unit 200 using removable fasteners such as bolts, nuts, screws, or rivets.

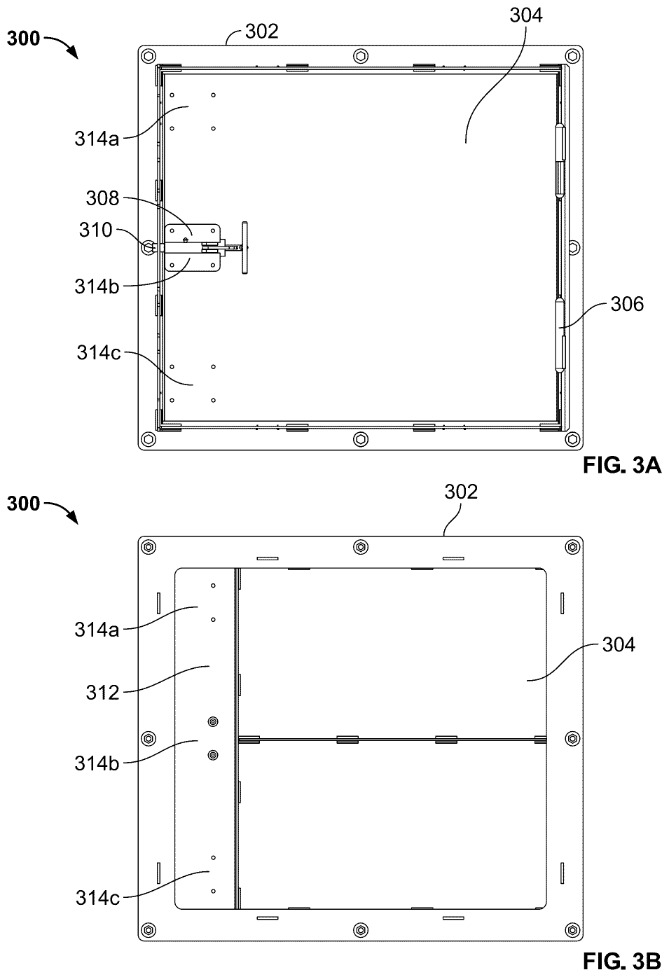

FIGS. 3A and 3B are front and back views, respectively, of an example door assembly 300 (also referred to as a door) for a modular hopper (e.g., modular hopper 102). The door assembly 300 includes a door frame 302, a door panel 304, a hinge 306, and a latch 308. The hinge 306 connects the door frame 302 and the door panel 304 and enables the door panel 304 to rotate with respect to the door frame 302. The hinge 306 can be attached to the door frame 302, for example, by welds, bolts, nuts, screws, rivets, etc. Similarly, the hinge 306 can be attached to the door panel 304 by welds, bolts, nuts, screws, rivets, etc. In a closed position, the latch 308 holds the door panel 304 in place with respect to the door frame 302. For example, the latch 308 can include a sliding bolt 310 that extends through a portion of the door frame 302 when the door panel 304 is in the closed position.

The door panel 304 includes a reinforced portion 312 on the back side of the door panel 300 on the edge where the latch 308 is mounted. The reinforced portion 312 facilitates attachment of the latch 308 to the door panel 304. The latch 308 can be mounted in any of three locations 314a-c on the door panel 304.

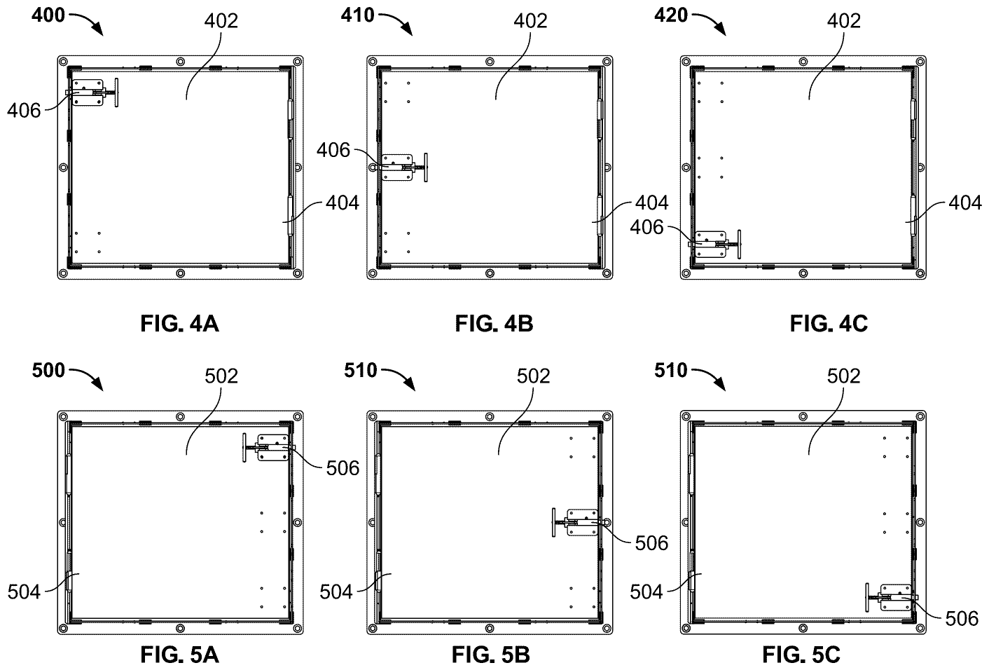

FIGS. 4A-4C are front views of example door configurations 400, 410, 420 for a modular hopper with the hinge 404 on the right side of the door 402 and the latch 406 on the left side of the door 402. In configuration 400, the latch 406 is mounted in the top position on the door 402. In configuration 410, the latch 406 is mounted in the middle position on the door 402. In configuration 420, the latch 406 is mounted in the bottom position on the door 402.

FIGS. 5A-5C are front views of example door configurations 500, 510, 520 for a modular hopper with the hinge 504 on the left side of the door 502 and the latch 506 on the right side of the door 502. In configuration 500, the latch 506 is mounted in the top position on the door 502. In configuration 510, the latch 506 is mounted in the middle position on the door 502. In configuration 520, the latch 506 is mounted in the bottom position on the door 502.

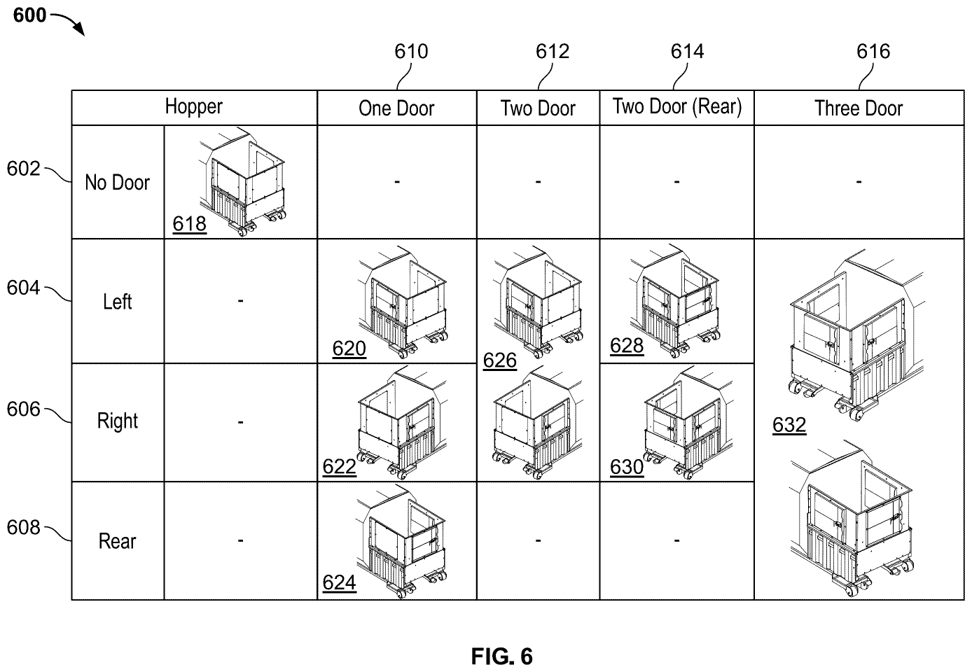

FIG. 6 is a grid 600 showing possible door and cover plate configurations for a modular hopper. There are three openings (left side wall, right side wall, and rear wall) in the base unit of the modular hopper that can accommodate a door or cover plate. In the configurations shown, openings not including a door can be covered with a cover plate, or alternatively, the openings not including a door can be left open depending on the needs of a particular application. The modular hopper in the grid 600 does not include a roof. The rows represent the position of the doors in the modular hopper unit. Row 602 includes no doors. Row 604 includes a door on the left side wall. Row 606 includes a door on the right side wall. Row 608 includes a door on the rear wall. The columns represent the number of doors included in the modular hopper. Column 610 includes one door. Column 612 includes two doors. Column 614 includes two doors with one of the doors attached to the rear wall. Column 616 includes three doors.

Configuration 618 does not include any doors in the modular hopper. The top of the modular hopper is open to receive refuse. In some implementations, one or more of the cover plates covering the openings of the modular hopper can be removed to allow refuse to be received into the compactor system through one of the openings in addition to receiving refuse through the top of the modular hopper.

Configuration 620 includes one door installed on the left side wall of the modular hopper. The openings in the right wall and rear wall are covered with cover plates. Configuration 622 includes one door installed in the right side wall with the openings in the left side wall and rear wall covered with cover plates. Configuration 624 includes one door installed in the rear wall with the openings in the left wall and the right wall covered with cover plates. In some implementations, the openings not covered by a door can be left uncovered.

Configuration 626 includes a modular hopper with two doors installed. One door is installed in the left wall, and one door is installed in the right wall. The opening in the rear wall is covered with a cover plate. Alternately, the opening in the rear wall can be left open.

Configuration 628 includes a modular hopper with two doors installed. One door is installed in the left wall and one door is installed in the rear wall. The opening in the right wall is covered with a cover plate. Configuration 630 includes a modular hopper with two doors. One door is installed in the right wall, and one door is installed in the rear wall. The opening in the left wall is covered with a cover plate. In some implementations, the openings not covered by a door can be left open.

Configuration 632 includes a modular hopper with three doors installed. One door is installed in each of the left wall, the right wall, and the rear wall.

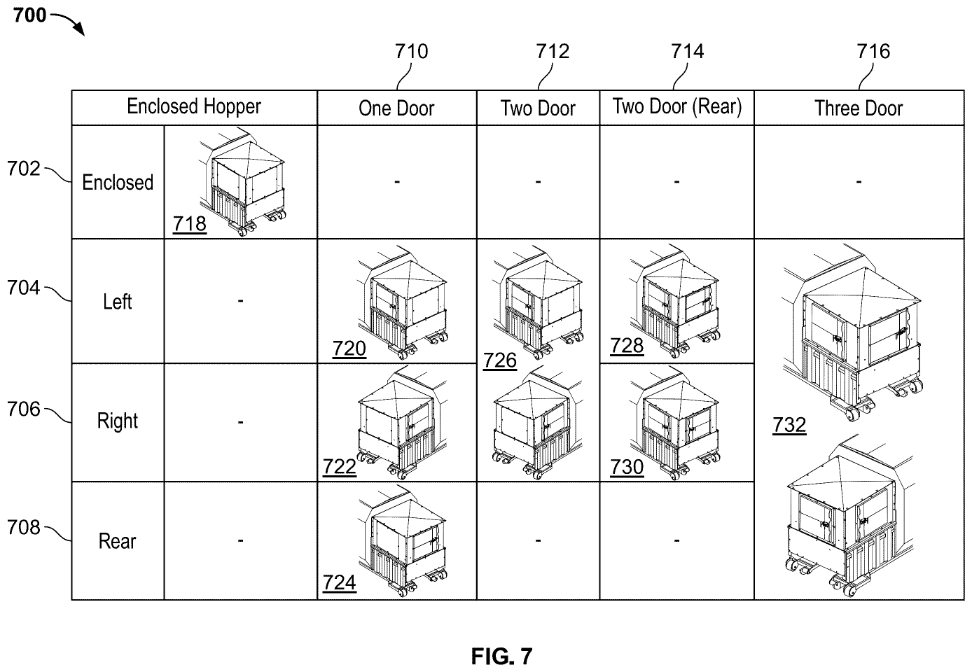

FIG. 7 is a grid 700 showing possible door and cover plate configurations for an enclosed modular hopper also colloquially referred to as a doghouse. There are three openings (left side wall, right side wall, and rear wall) in the base unit of the modular hopper that can accommodate a door or cover plate. In the configurations shown, openings not including a door can be covered with a cover plate, or alternatively, the openings not including a door can be left open depending on the needs of a particular application. The modular hoppers shown in the grid 700 include a roof. The rows represent the position of the doors in the modular hopper unit. Row 702 includes no doors. Row 704 includes a door on the left side wall. Row 706 includes a door on the right side wall. Row 708 includes a door on the rear wall. The columns represent the number of doors included in the modular hopper. Column 710 includes one door. Column 712 includes two doors. Column 714 includes two doors with one of the doors attached to the rear wall. Column 716 includes three doors.

Configuration 718 does not include any doors in the modular hopper. One or more of the cover plates covering the openings of the modular hopper can be removed to allow refuse to be received into the compactor system through one of the openings in addition to receiving refuse through the top of the modular hopper. In some implementations, one or more of the openings are not covered by a cover plate.

Configuration 720 includes one door installed on the left side wall of the modular hopper. The openings in the right wall and rear wall are covered with cover plates. Configuration 722 includes one door installed in the right side wall with the openings in the left side wall and rear wall covered with cover plates. Configuration 724 includes one door installed in the rear wall with the openings in the left wall and the right wall covered with cover plates. In some implementations, the openings not covered by a door can be left uncovered.

Configuration 726 includes a modular hopper with two doors installed. One door is installed in the left wall, and one door is installed in the right wall. The opening in the rear wall is covered with a cover plate. Alternately, the opening in the rear wall can be left open.

Configuration 728 includes a modular hopper with two doors installed. One door is installed in the left wall and one door is installed in the rear wall. The opening in the right wall is covered with a cover plate. Configuration 730 includes a modular hopper with two doors. One door is installed in the right wall, and one door is installed in the rear wall. The opening in the left wall is covered with a cover plate. In some implementations, the openings not covered by a door can be left open.

Configuration 732 includes a modular hopper with three doors installed. One door is installed in each of the left wall, the right wall, and the rear wall.

The doors in the configurations 620-632 and 720-732 can be installed in any of the door configurations described with reference to FIGS. 4A-5C. For example, the door hinge can be on either edge of the door with the latch on the opposite edge. The latch can be installed in any of the top, middle, or bottom latch positions. In some implementations, more than one latch can be installed on a single door. The doors in a single modular hopper configuration can be configured differently from one another. For example, and without limitation, in configurations 626 or 726, the door installed on the left wall can have a hinge on the right side and the latch in the top position while the door installed on the right wall can have the hinge on the left side with the latch in the middle position.

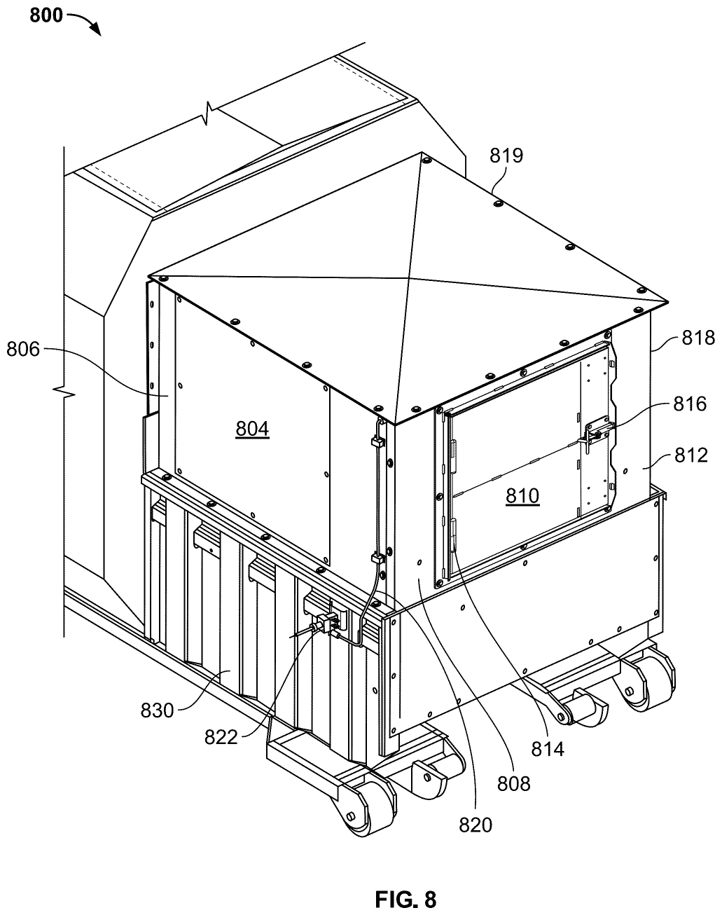

FIG. 8 is a perspective view of a compactor system 800 including a modular hopper 802. The modular hopper 802 is attached to the packer 830. The modular hopper 802 includes a cover plate 804 installed on the left wall 806 of the base unit 808. A door 810 is installed on the rear wall 812. The door 810 includes a hinge 814 on the left side of the door 810 and a latch 816 in the middle position on the right side of the door 810. The right wall 818 can include a cover plate or a door to cover the opening in the right wall. A roof 819 is attached to each of the left wall 806, the rear wall 812, and the right wall 818.

The compactor system 800 includes an interlock system 820 electrically connected to the compactor controls 822. The interlock system 820 includes one or more sensors to detect if the door 810 is closed. For example, the sensor can be a spring biased push button switch that is extended when the door 810 is in the open, and depressed when the door 810 is closed. Depressing the switch will close an electronic circuit indicating that the door 810 is in the closed position. Other examples of interlock sensors that can be used in interlock system 820 include roller arm sensor, keyed sensors, magnetic sensors, solenoids, or other types of sensors that can detect the open or closed state of the door. The interlock system 820 will prevent operation of the compactor controls 822 if the sensor detects that the door 810 is not in the closed position. If the right wall 818 also includes a door, the interlock system 820 can include a sensor to detect if the door in the right wall is closed. The interlock system 820 will prevent operation of the compactor controls 822 when any door is not detected in the closed position.

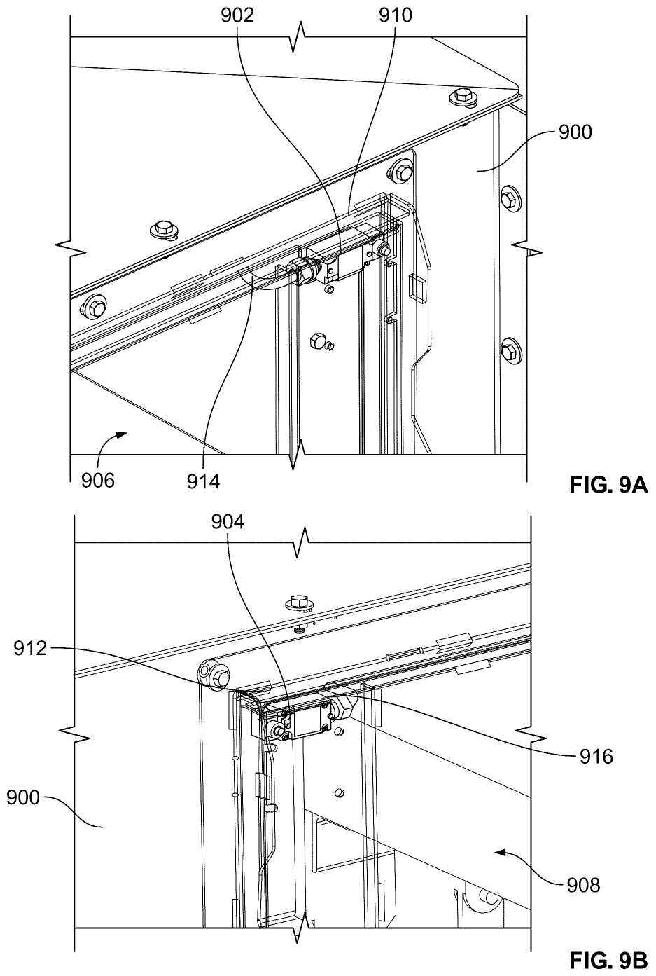

FIGS. 9A-9B are perspective detail views of example interlock sensors 902, 904 for an interlock system (e.g., interlock system 820) installed on a base unit 900 of a modular hopper. The interlock sensors 902, 904 are installed in the corner of the respective openings 906, 908 on the interlock attachment points 910, 912 on the base unit 900 (e.g., similar to interlock attachment points 210 shown in FIG. 2A). The interlock sensors 902, 904 are attached on the interlock attachment points 910, 912 opposite the hinge of the door covering the openings 906, 908. When the doors are in the closed positions, the interlock sensors 902, 904 send a signal via wires 914, 916 to the compactor control system to indicate that the doors are closed and the compactor system can be operated. When the doors are in the open position, the interlock sensors 902, 904 do not send a signal to the compactor controls. The compactor controls are unable to operate the compactor system in the absence of a signal enabled by the interlock sensors 902, 904.

In an example method for assembling a modular hopper (e.g., modular hopper 102) on a compactor system (e.g., compactor system 100) a worker obtains a first side wall, a second side wall, and a rear wall for the modular hopper. The worker removably fastens (e.g., bolts, screws, rivets) the first side wall, the second side wall, and the rear wall to the compactor system. The worker removably fastens, a rear edge of the first side wall to the rear wall and a rear edge of the second side wall to the rear wall on an edge opposite the edge where the first side wall is removably fastened. The worker removably fastens front edges of the first and second side walls to the compactor system (e.g., to the container body). The worker removably fastens one or more doors or cover plates to one or more of the first and second side walls and the rear wall.

In some implementations, the worker removably fastens a roof to the first and second side walls and the rear wall.

In some implementations, the worker removably fastens a hinge and a latch to the one or more doors. The worker can select a location to fasten the hinge and the latch to the door from a set of predetermined locations on the one or more doors. Each predetermined location includes a standard attachment pattern for removably fastening the hinge and the latch.

In some implementations, the worker seals joints between the first and second side walls, the rear wall, and the compactor system.

In some implementations, the worker can reconfigure the modular hopper by removing a door from the first side wall; and removably fastening the door to the second side wall or the rear wall.

In some implementations, during reconfiguration, the worker removes a latch in a first position from the door; and the worker removably fastens the latch to the door in a second position different than the first position.

In some implementations, the worker removably fastens an interlock system to the one or more doors to prevent operation of the compactor system when the one or more doors are in an open position.

Modular hoppers can be assembled by workers with less skills than a conventional hopper. For example, a worker assembling a modular hopper does not need to be able to weld while a worker assembling a conventional hopper welds the hopper together and to the compactor system. A modular hopper can also be assembled in less time than a conventional hopper because fastening the various components together can take less time than welding the components together. Since the components of the modular hopper (e.g., doors, latches, cover plates) are interchangeable modular hoppers can decrease parts kept in inventory. Modular hoppers also provide flexibility for easily modifying a hopper while the compactor system is deployed in the field, and/or when the compactor system is changing locations.

In some implementations, the modular hopper is shipped as a kit to a user in a disassembled condition, and the user assembles the parts of the kit to form the modular hopper. The kit can include the components of the modular hopper as described herein. For example, the kit can include two side walls and a rear wall to form a base unit of the modular hopper. The kit can include a roof to attach to the base unit. The kit can include one or more doors with each door including a door panel attached to a door frame. The kit can include one or more latches to be mounted on the door panels to latch the door panel to the door frame. The kit can include one or more cover plates. The kit can include an interlock sensor and/or an interlock system. The parts of the kit can be shipped in multiple shipments where each shipment includes on or more parts of the kit. Alternatively, the parts of the kit can be shipped together in a single shipment.

Although the preceding detailed description contains many specific details for purposes of illustration, it is understood that one of ordinary skill in the art will appreciate that many examples, variations and alterations to the details are within the scope and spirit of the disclosure. Accordingly, the exemplary implementations described in the present disclosure and provided in the appended figures are set forth without any loss of generality, and without imposing limitations on the claimed implementations.

Although the present implementations have been described in detail, it should be understood that various changes, substitutions, and alterations can be made hereupon without departing from the principle and scope of the disclosure. Accordingly, the scope of the present disclosure should be determined by the following claims and their appropriate legal equivalents.

The singular forms “a”, “an” and “the” include plural referents, unless the context clearly dictates otherwise.

As used in the present disclosure and in the appended claims, the words “comprise,” “has,” and “include” and all grammatical variations thereof are each intended to have an open, non-limiting meaning that does not exclude additional elements or steps.

As used in the present disclosure, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the present disclosure.

What is claimed is:

1. A modular hopper for a compactor system, the modular hopper comprising:
a first side wall comprising a rear edge, a back edge, a top edge, and a bottom edge;
a second side wall comprising a rear edge, a back edge, a top edge, and a bottom edge;
a rear wall removably fastened to the rear edge of the first side wall along a first edge and removably fastened to the rear edge of the second side wall along a second edge opposite the first edge; and
each of the first side wall, the second side wall, and the rear wall defining a refuse receiving opening configured to enable access to an interior of the modular hopper, the refuse receiving openings defined in the first side wall, the second side wall, and the rear wall having substantially similar dimensions;
wherein the modular hopper is configured to be removably fastened to a compactor system.

2. The modular hopper of claim 1, wherein the back edges of the first side wall and the second side wall are configured to be removably fastened to the compactor system.

3. The modular hopper of claim 1, wherein the first side wall, the second side wall, and the rear wall are configured to be removably fastened to the compactor system along a bottom edge of the respective first side wall, the second side wall and the rear wall.

4. The modular hopper of claim 1, further comprising a roof removably fastened to the top edge of the first side wall, the second side wall, and the rear wall.

5. The modular hopper of claim 1, further comprising one or more doors removably fastened to one or more of the first side wall, the second side wall, and the rear wall, wherein the one or more doors comprise:
a hinge to allow the door to rotate from a closed position sealing the refuse receiving opening in the first side wall, the second side wall, or the rear wall, and an open position that allows access to the refuse receiving opening; and
a latch to secure the door when in the closed position.

6. The modular hopper of claim 5, further comprising an interlock system attached to the modular hopper configured to prevent operation of the compactor system when the one or more doors are in the open position.

7. The modular hopper of claim 5, further comprising one or more cover plates removably fasted to one or more of the first side wall, the second side wall and the rear wall, the one or more cover plates covering the refuse receiving opening in the respective wall.

8. The modular hopper of claim 1, wherein the first side wall, the second side wall, and the rear wall include a standard bolt pattern surrounding the refuse receiving openings to allow interchangeability of doors and cover plates.

9. The modular hopper of claim 1, wherein joints between the first side wall, the second side wall, the rear wall, and the compactor system comprise a sealant to reduce liquid seepage through the joints.

10. The modular hopper of claim 1, wherein removably fastened comprises being fastened with one or more of bolts, nuts, screws, and rivets.

11. A compactor system comprising:
a packer comprising a ram;
a container body;
hydraulics for actuating the ram to compact debris contained within the packer to the container body; and
a modular hopper configured to receive debris into the packer, the modular hopper comprising:
a first side wall comprising a rear edge, a back edge, a top edge, and a bottom edge;
a second side wall comprising a rear edge, a back edge, a top edge, and a bottom edge;
a rear wall removably fastened to the rear edge of the first side wall along a first edge and removably fastened to the rear edge of the second side wall along a second edge opposite the first edge; and
each of the first side wall, the second side wall, and the rear wall defining a refuse receiving opening configured to enable access to an interior of the modular hopper, the refuse receiving openings defined in the first side wall, the second side wall, and the rear wall having substantially similar dimensions;
wherein the modular hopper is configured to be removably fastened to the packer, the container body, or both.

12. The system of claim 11, wherein the back edges of the first side wall and the second side wall are configured to be removably fastened to the container body.

13. The system of claim 11, wherein the first side wall, the second side wall, and the rear wall are configured to be removably fastened to the packer along a bottom edge of the respective first side wall, the second side wall and the rear wall.

14. The system of claim 11, wherein the modular hopper further comprises a roof removably fastened to the top edge of the first side wall, the second side wall, and the rear wall.

15. The system of claim 11, further comprising one or more doors removably fastened to one or more of the first side wall, the second side wall, and the rear wall, wherein the one or more doors comprise:
a hinge to allow the door to rotate from a closed position sealing the refuse receiving opening in the first side wall, the second side wall, or the rear wall, and an open position that allows access to the refuse receiving opening; and
a latch to secure the door when in the closed position.

16. The system of claim 15, further comprising an interlock system attached to the modular hopper configured to prevent operation of the compactor system when the one or more doors are in the open position.

17. The system of claim 15, further comprising one or more cover plates removably fasted to one or more of the first side wall, the second side wall and the rear wall, the one or more cover plates covering the refuse receiving opening in the respective wall.

18. The system of claim 11, wherein the first side wall, the second side wall, and the rear wall include a standard bolt pattern surrounding the refuse receiving openings to allow interchangeability of doors and cover plates.

19. The system of claim 11, wherein joints between the first side wall, the second side wall, the rear wall, and the packer and/or the container body comprise a sealant to reduce liquid seepage through the joints.

20. The system of claim 11, wherein removably fastened comprises being fastened with one or more of bolts, nuts, screws, and rivets.

21. A method for assembling a modular hopper on a compactor system, the method comprising:
obtaining a first side wall; a second side wall, and a rear wall for a modular hopper;
removably fastening the first and second side walls and the rear wall to the compactor system;
removably fastening the first side wall to a first edge of the rear wall;
removably fastening the second side wall to a second edge of the rear wall opposite the first edge;
removably fastening a front edge of the first and second side walls to the compactor system; and
removably fastening one or more doors or cover plates to one or more of the first and second side walls and the rear wall.

22. The method of claim 21, further comprising removably fastening a roof to the first and second side walls and the rear wall.

23. The method of claim 21, further comprising removably fastening a latch to the one or more doors.

24. The method of claim 23, wherein a location to fasten the latch to the door is selected from a set of predetermined locations on the one or more doors, each predetermined location comprising a standard attachment pattern for removably fastening the latch.

25. The method of claim 21, further comprising sealing joints between the first and second side walls, the rear wall, and the compactor system.

26. The method of claim 21, wherein removably fastening comprises fastening with one or more of bolts, nuts, screws, and rivets.

27. The method of claim 21, further comprising removing a door from the first side wall; and removably fastening the door to the second side wall or the rear wall.

28. The method of claim 27, wherein removably fastening the door to the second side wall or the rear wall comprises removing a latch in a first position from the door; and removably fastening the latch to the door in a second position different than the first position.

29. The method of claim 21, further comprising removably fastening an interlock system to the one or more doors to prevent operation of the compactor system when the one or more doors are in an open position.
